(19) United States
(12) Patent Application Publication
(10) Pub. No.: US 2012/0184041 A1
(43) Pub. Date: Jul. 19, 2012

(54) Apparatus and Method for Detecting and/or Quantifying Compounds of Interest Present in Gaseous Form or Dissolved In A Solvent

(75) Inventors: Alexandre Carella, Mazeres Lezons (FR); Jean-Pierre Simonato, Sassenage (FR)

(73) Assignee: Commissariat A L'Energie Atomique Et Aux Energies Alternatives, Paris (FR)

(21) Appl. No.: 13/496,600

(22) PCT Filed: Sep. 17, 2010
(86) PCT No.: PCT/FR2010/000630

§ 371 Date: Apr. 5, 2012

(30) Foreign Application Priority Data
Sep. 18, 2009 (FR) 09 04468

(51) Int. Cl. G01N 27/00

(52) U.S. Cl. 436/81; 436/106; 422/82.01; 436/104; 422/98

(57) ABSTRACT

The invention relates to an apparatus and method for detecting and/or quantifying compounds of interest present in gaseous form or dissolved in a solvent. The apparatus according to the invention includes an electrical device including two electrodes, and a device for measuring the variation in charges between the two electrodes of the electrical device. The electrical device includes a layer made of an insulating dielectric material onto which a layer of receptor molecules is grafted, and finally, a layer of semiconductor material is deposited onto the receptor molecule layer. The invention can be used in the field of detecting and/or quantifying compounds of interest present, in particular, in a gas or in a solution.

The invention relates to an apparatus and to a method for detecting and/or quantifying compounds of interest present in gaseous form or in solution in a solvent.

Many compounds, which may be in gaseous form or else in solution in a solvent, must be able to be detected and/or quantified rapidly, directly at the site of operation, and selectively.

Such compounds are, for example, organophosphorus compounds that are molecules constituted of a phosphate atom to which various chemical groups are bonded, the nature of said groups determining the exact properties of the compound. Organophosphorus compounds, which were the subject of intensive research on combat gases during and after the Second World War, which resulted in the development of the gases sarin, soman, tabun, cyclosarin, GV, VX, VE, VG and VM, and of molecules which simulate the action of neurotoxic organophosphorus compounds, of the type DFP (diisopropyl fluorophosphate), DCP (diethyl chlorophosphate) and DMMP (dimethyl methylphosphonate), are today mainly used in agriculture as insecticides or herbicides. Among the large variety of organophosphorus compound-based pesticides that exist, mention may in particular be made of parathion, malathion, methyl parathion, chlorpyrifos, diazinon, dichlorvos, phosmet, tetrachlorvinphos and methyl azinphos.

The mode of action of organophosphorus compounds is based on the affinity of the latter for an enzyme involved in nerve impulse transmission: cholinesterase. Organophosphorus compounds in fact have the property of binding particularly strongly and stably to the active site of this enzyme. Once bound, the organophosphorus compound prevents the cholinesterase from degrading acetylcholine, a neurotransmitter released at the neuronal synapses during neuronal excitation: through a lack of degradation of acetylcholine to inactive choline and acetyl compounds, the neurones are constantly excited, which may lead to paralysis of the central nervous system and result in death.

Since the mechanism involved in nerve impulse transmission which is blocked by organophosphorus compounds is identical throughout the animal kingdom, the organophosphorus compounds used as insecticides are not only toxic to insects, but also to any animal, including humans. For this reason, despite their relatively good biodegradability which has enabled them to replace organochloro compound-based insecticides which have a poor biodegradability, their much greater toxicity requires particular precautions for use. Specifically, organophosphorus compounds can pose very serious problems owing to accumulation in the environment or throughout the food chain in the case of the presence of residues on plants, in water, or in meat from animals that have consumed foods containing organophosphorus compounds. Since these insecticides are among those most widely used, not only in agriculture by individuals working in the industry, but also by private individuals, the detection and the quantitative determination of organophosphorus compounds represent a public health interest and would also be particularly useful for the agri-food industry.

In addition, despite being banned in 1997, combat gases are still a threat. On the one hand, the production of combat gases of the sarin, toman or VX type is easy and, on the other hand, since these compounds are odorless and colorless, they can be inhaled without the individual realizing it. The immediate detection of the presence of such gases therefore represents a major issue for protecting soldiers in the combat zone, but also civilian populations in the face of the risk of terrorism. These threats are clearly established, especially since the deadly sarin attack carried out by the terrorist group Aum Shinrikyo in the Tokyo subway in 1995.

Many methods and devices for detecting organophosphorus compounds have been developed.

Thus, chemical sensors sensitive to organophosphorus gases, most of which operate on the “electronic nose” principle, are sold. Patent U.S. Pat. No. 5,571,401, for example, describes a chemical sensor constituted of arrays comprising a resistor composed of nonconductive polymers and of conductive materials: when a chemical molecule comes into contact with the conductive materials, a difference in resistance is then detected. These sensors have the drawback of not being very specific and of being very sensitive to false positives. Sensors based on two-dimensional grids of carbon nanotubes have also been developed (WO 2006/099518), but, although they are very sensitive and detect a large number of molecules, they do not make it possible to obtain a specific and selective response for organophosphorus compounds.

Recently, selective detection methods for organophosphorus compounds in solution, based on measuring fluorescence, have been described. Zhang et al. have shown that, in the presence of a molecule having an amine in spatial proximity to a primary alcohol and a non-planar, flexible and weakly conjugated chromophore, organophosphorus compounds react with the primary alcohol, the phosphate obtained enabling cyclization by intramolecular nucleophilic substitution, stabilizing the chromophore in the plane and resulting in an increase in fluorescence (S.-W. Zhang and T. M. Swager, J. Am. Chem. Soc., 2003, 125, 3420-3421). This cyclization therefore enables detection, by fluorescence, of the organophosphorus agents in solution. The team of J. Rebek, Jr. subsequently showed that some Kemp's acid derivatives comprising a primary alcohol close to a tertiary amine are also good candidates for detecting neurotoxic organophosphorus species (T. J. Dale & J. Rebek, Jr., J. Am. Chem. Soc., 2006, 4500-4501). As S.-W. Zhang et al. had previously shown, when the primary alcohol reacts with an organophosphorus compound, the phosphate obtained enables cyclization by intramolecular nucleophilic substitution and the obtaining of a quaternary ammonium according to the reaction shown in the scheme below:

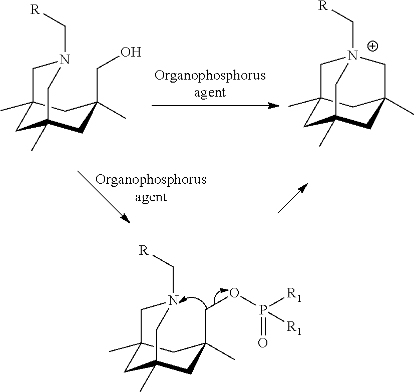

Rebek et al. then developed Kemp's acid derivatives in which R is a fluorophore. In its open form, the fluorescence is prevented by a photoinduced electron transfer due to the amine. The cyclization abolishes this electron transfer and increases the fluorescence of the molecule. A 5-second exposure of a filter comprising Kemp's acid coupled to a fluorophore in an atmosphere comprising 10 ppm of DFP enables the detection of this organophosphorus compound by fluorescence, by reading under a UV lamp. Although this detection is specific, it has various drawbacks. First of all, it must be carried out in a low light environment. It cannot therefore always be used on premises where the presence of organophosphorus compounds is to be detected and in real time. Furthermore, it requires the use of a UV lamp, which increases the bulk and therefore reduces the portable nature of the device for detecting and/or quantifying the organophosphorus compounds.

Methods based on the use of a biosensor comprising enzymes which have an affinity for organophosphorus compounds, for example cholinesterase, have also been developed. In PCT Application WO 2004/040004, unicellular algae which express acetylcholinesterase at the membrane have been used to test for the presence of organophosphorus compounds in an aqueous medium, the percentage inhibition of acetylcholinesterase being correlated with the concentration of organophosphorus compounds in the aqueous liquid tested. This method requires the solubilization of the organophosphorus compounds prior to the detection thereof.

Ishii A. et al. describe a sensor based on carbon nanotubes for detecting organophosphorus insecticides.

This sensor comprises two electrodes, a substrate coated, on one face, with an insulating material, onto which insulating material a molecule of acetylcholinesterase which detects the organophosphorus compounds is grafted and, on the other face, with a semiconductor material.

A device for measuring the current flowing between the two electrodes makes it possible to detect the presence of organophosphorus compounds.

This sensor comprises “active” parts on each of the faces.

Thus, on one face, the active part is the molecule which detects the organophosphorus compounds and, on the other face, the active part is represented by the electrical device itself, that is to say the layer of semiconductor material and the electrodes.

Thus, the manufacture of this sensor and its integration into a device are tricky because it is necessary, during its manufacture, to turn over the substrate and protect the “activated” face already generated, which curbs its ease of manufacture and generates sources of deterioration of the sensor.

This also implies that during the integration of these sensors in a more complete device, it is necessary to make provision to protect and leave accessible the two faces of the sensor.

Finally, with this type of sensor, it is only possible to detect organophosphorus compounds in solution.

PCT application WO 2006/099518 A2 itself describes a sensor comprising a substrate coated with a layer of thermal oxide and with a grid of nanotubes and two electrodes and also a device for measuring the difference in capacitance between the two electrodes.

This document also teaches that receptor molecules that make it possible to detect organophosphorus compounds may be deposited on the silicon oxide surface, after the deposition of the nanotubes and that these molecules partially cover the nanotubes.

But the sensitivity of this type of sensor is limited by the fact that it is not possible to deposit or graft a large number of molecules onto the layer of thermal oxide, since this layer cannot be surface-activated, before the grafting of the receptor molecules, because this activation, which is generally carried out by plasma, ozonolysis or a treatment with a solution containing hydrofluoric acid and nitric acid (piranha solution), would damage the semiconductor layer, i.e. here the carbon nanotubes.

In summary, the methods for detecting organophosphorus compounds that are currently available have the drawback either that they are not selective for organophosphorus compounds, or that they can be used only for testing a sample in solution, or that they require a fluorescence reader and a low light environment. The development of a rapid, effective and specific method for the selective detection of organophosphorus compounds both in gaseous form and in solution, in any medium, irrespective of the light intensity thereof, and also the development of a compact and readily portable device for simple, rapid and selective detection therefore still represent major issues in the protection of soldiers in the combat zone and of civilian populations exposed to the risk of terrorism, and more broadly for the detection of organophosphorus pesticides.

Other compounds of interest are mercuric ions Hg²⁺.

It is well known that mercury is a toxic and/or ecotoxic compound in all of its organic forms and in respect of all of its chemical states.

The reason is that mercury accumulates within organisms and is the cause of numerous diseases, affecting particularly the kidneys, the digestive system, and the neurological system.

Of all the oxidation states, it is the ions of mercury II, Hg²⁺, that are the most toxic.

The development of selective sensors for this element is of particular interest for the purposes of quantifying and detecting this element in the natural environment, water, and foods.

Moreover, determining the concentration of mercury in water intended for food use is necessary within the context of regulations concerning drinking water and concerning hazardous materials.

The technique used at present for quantifying mercury in water is that of atomic absorption spectroscopy.

This technique, although accurate and reliable, has a number of drawbacks.

In particular, it involves heavy equipment which is difficult to transport.

Mercuric compounds may also be detected using selective fluorescent and colorimetric sensors, by grafting chromophores or fluorophores onto dithia-dioxa-monoaza crown ether compounds.

The dithia-dioxa-monoaza crown ether compounds complex the Hg²⁺ ions selectively, and this complexation produces a change in the properties of the chromophores or fluorophores bound to them.

This change in optical properties of the chromophores or of the fluorophores is due to an electron-attracting effect of the mercury, which depletes the chromophore.

Accordingly, Zhu et al., in Org. Lett., 2008, 10, 1481-1484, propose a chemical sensor for mercuric ions Hg²⁺, in which a dithia-dioxa-monoaza crown ether compound, to which a tricarbocyanine dye is grafted, is used to complex the Hg²⁺ ions, and thus causes a change in color of the dye when the Hg²⁺ ions are complexed by the crown ether.

This change in color is visible to the naked eye.

However, this technique does not allow the detection of small quantities of Hg²⁺ ions and, moreover, does not allow the concentration of Hg²⁺ in the sample under analysis to be determined.

The same document indicates that the detection of mercuric ions Hg²⁺ may also be accomplished by analyzing the fluorescence emitted by the dye grafted onto the crown ether.

This technique, apart from the impossibility of determining the concentration of Hg²⁺ ions, has the drawback of having to be performed in a low light environment, and this does not allow it to be performed directly on site.

U.S. Pat. No. 7,385,267 B2 describes electrical devices in which nanotubes or nanowires of a conductive material are functionalized with a molecule which undergoes a change in property on contact with an analyte to be detected within a sample.

This device allows the analyte in the sample to be detected by detecting, the change in property of the conductive material.

There is no reference in that document to the detection of Hg²⁺ ions or to the modification of the conduction properties of a semiconductor material bonded to which is a compound which complexes mercuric ions Hg²⁺ when contacted with the Hg²⁺ ions.

Other compounds of interest are nitrogen-containing compounds, more particularly nitrogen-containing explosives such as TNT and basic molecules such as ammonia.

Accordingly, a need exists for an apparatus for detecting and/or quantifying compounds of interest that are present in gaseous form in the air for example, or else in solution in water or in an unknown solvent, it being possible for said apparatus to be used directly on site, irrespective of the light conditions, to be transportable, to have a high sensitivity and to be manufactured easily and on a large scale.

In order to satisfy this need, the invention proposes using the variation in charge induced at the time of the introduction of a molecule known as a “receptor” molecule comprising a group that reacts with the compounds of interest, either via complexation or via cyclization or any, other chemical reaction, in order to highlight the presence of, and to quantify the compound of interest in the sample to be analyzed.

More specifically, the invention proposes an apparatus for selectively detecting and/or quantifying compounds of interest present in gaseous form or in solution in a solvent comprising:
an electrical device comprising:
   two electrodes,
   a layer of insulating dielectric material,
   a layer comprising a layer of receptor molecule comprising at least one receptor molecule A grafted to the layer of insulating dielectric material, said receptor molecule comprising a group R₁ capable of reacting with the compounds of interest, and
   a layer of semiconductor material deposited on the layer of receptor molecule, and
a device for detecting and/or measuring the variation of positive charges between the two electrodes.

Preferably, the receptor molecule A furthermore comprises a group R that enables it to be grafted to the layer of insulating dielectric material.

In a first embodiment of the apparatus for selectively detecting and/or quantifying compounds of interest of the invention, the insulating dielectric material is chosen from insulating dielectric materials based on silicon, insulating dielectric materials based on aluminum or on hafnium and organic insulating dielectric materials.

In a second, more particularly preferred embodiment of the apparatus for selectively detecting and/or quantifying compounds of interest of the invention, the insulating dielectric material is chosen from silicon oxide, aluminum oxide and polyhexene diimide.

In a first preferred embodiment, the insulating dielectric material is based on silicon, preferably is silicon oxide (SiO₂), and the group R of the receptor molecule A is a trihalosilane or tri(C₁ to C₄)alkoxysilane group, preferably a trimethoxysilane group.

In a second preferred embodiment, the insulating dielectric material is based on aluminum, preferably is aluminum oxide (Al₂O₃), and the group R of the receptor molecule A is a trihalosilane or tri(C₁ to C₄)alkoxysilane group, preferably a trimethoxysilane group.

In a third preferred embodiment, the insulating dielectric material is an organic dielectric insulating material, preferably is polyhexene diimide, and the group R of the receptor molecule A is a trihalosilane or tri(C₁ to C₄)alkoxysilane group, preferably a trimethoxysilane group.

The receptor molecule A may furthermore comprise a spacer part connecting the group. R to the group R₁, this spacer part being constituted of a linear or branched C₁ to C₂₀ inclusive hydrocarbon-based chain, and possibly containing at least one heteroatom and/or aromatic radical and/or heteroaromatic radical.

In a first method of implementation, the compounds of interest are organophosphorus compounds and the group R₁ of the receptor molecule A is a group constituted of a primary alcohol group located in spatial proximity to a tertiary amine group.

In this first method of implementation, said receptor molecule A may be a molecule obtained from Kemp's acid and has the general formula (I) below:

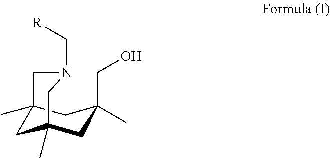

in which R represents the grafting group, optionally provided with the spacer part.

As can be seen, in this formula (I), the group R₁ of the receptor molecule A is a 1,5,7-trimethyl-3-azabicyclo[3.3.1]nonane-7-methanol group.

But said receptor molecule A may also be a molecule of general formulae (II) or (III) below:

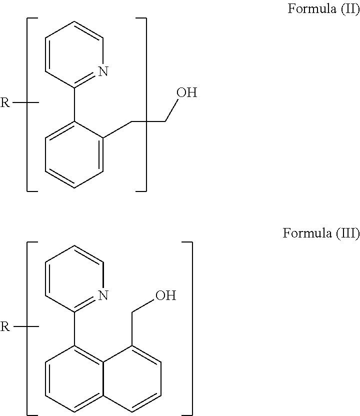

in which R represents the grafting group, optionally provided with the spacer part.

In this case, preferably, the group R is a trimethoxysilane group.

In a second method of implementation of the apparatus of the invention, the compounds of interest are mercuric ions Hg²⁺, and the group R₁ of the receptor molecule A is chosen from a dithia-dioxa-monoaza crown ether compound, an N,N′-(hydroxyethyl)amine, an N,N′-(carboxyethyl)amine and mixtures of at least two of these compounds.

Preferably, the group R₁ of the receptor molecule A is a dithia-dioxa-monoaza crown ether group.

In a third method of implementation of the apparatus of the invention, the compounds of interest are nitrogen-containing compounds and the group R₁ of the receptor molecule A is a polymethoxyarene group, preferably dimethoxybenzene.

In a fourth method of implementation of the apparatus of the invention, the compounds of interest are basic compounds and the group R₁ of the receptor molecule A is an acid group.

In all the embodiments and methods of implementation of the apparatus of the invention, the electrical device may be of resistive type.

But the electrical device may also, and preferably, be a field-effect transistor.

As regards the layer of semiconductor material, preferably it is a layer of carbon nanotubes and/or nanowires based on Si and/or graphene sheets.

The invention also proposes a method for detecting and/or quantifying compounds of interest, characterized in that it comprises the following steps:
a) contacting of the sample liable to contain the compounds of interest with the at least one receptor molecule A of the detecting and/or quantifying apparatus, and
b) reading the charge variation induced by the reaction of the receptor molecule A with the compound of interest by measuring the difference in current or voltage between the two electrodes of the electrical device.

The invention will be better understood and other features and advantages thereof will appear more clearly on reading the explanatory description which follows.

The apparatus for selectively detecting and/or quantifying compounds of interest present in a sample in gaseous form or else in solution in a solvent such as water or any other solvent comprises two devices which may of course be combined to give a single device:
an electrical device comprising two electrodes separated from one another by a layer of insulating dielectric material according to the invention, at least one receptor molecule A being grafted to this layer of insulating dielectric material, forming a layer of receptor molecule, which is then coated with a layer of a semiconductor material, and
a device for detecting and/or measuring the variation of the positive charges between the two electrodes of the electrical device.

Thus, it has surprisingly been discovered that when the receptor molecule A is coated with a layer of semiconductor material, it continues to react with the compound of interest to be detected with a high sensitivity.

Furthermore, the receptor molecules A may be grafted with a high surface density, of greater than 10¹³ molecules/cm² since it is possible to activate the surface of insulating material without damaging the layer of semiconductor material because the latter is not yet present, in order to create a large number of reactive sites for the grafting of the receptor molecules A.

Such a surface activation is not possible when the receptor molecules A must be grafted or deposited when the semiconductor material is already present.

Furthermore, this avoids any parasitic reaction between the semiconductor material, when it is already present, this semiconductor material itself having a certain number of surface defects, which are themselves reactive with the reactive functions (groups R and R₁) of the receptor molecules A.

The receptor molecules A do not in any case cover, even if it were only partially, the layer of semiconductor material.

The electrical device may be an electrical device of resistive type such as a transistor, which is a device constituted of a conductive material placed between two electrodes, or a device of field-effect transistor (FET) type.

Field-effect transistors have, which has already been demonstrated, excellent detection properties, especially gas detection properties.

Among the field-effect transistors, mention may be made of the carbon nanotube field-effect transistors (CNTFET) or Si nanowire transistors in which the layer of semiconductor material is a layer of carbon nanotubes or of Si nanowires.

Mention may also be made of the field-effect transistors in which the semiconductor material is an organic material (OFET).

As regards the electrodes of the electrical device, they may be metallic, for example made of gold, of silver, of palladium, of platinum, of titanium, doped silicon, of copper, of nickel or of silicide.

But the electrodes may also be made of a conductive material based on carbon nanotubes and/or made of poly(3,4-ethylene dioxythiophene)/poly(styrene sulfonate) (PEDOT/PSS).

As regards the layer of semiconductor material, it may be made of any semiconductor material that a person skilled in the art will come across.

Preferably, this is a material made of or based on carbon, silicon, germanium, zinc, gallium, indium, cadmium, or mixtures thereof.

In the invention, the expression “material based on X” denotes a material comprising at least 20 mol % of X relative to the total number of moles present in the material.

The semiconductor material could also be an organic semiconductor material such as oligomers, polymers or small molecules having a weight-average molecular weight of less than 1000 g.mol⁻¹, such as pentacene.

For example, the organic semiconductor materials may be materials based on heterocyclic aromatic compounds such as thiophene and quaterthiophene and derivatives thereof such as P3HT (poly-3-hexylthiophenes); pyrrole such as polypyrrole; an arylamine such as triphenylamine and derivatives thereof such as poly(triarylamine); heterocyclic macrocycles such as porphyrins such as tetraphenylporphyrin and phthalocyanines and derivatives thereof such as copper tetraphenylporphyrin and nickel phthalocyanine; aromatic polycyclic acenes such as pentacenes and derivatives thereof such as triisopropylsilyl pentacene; arylenes such as pyrene, and derivatives thereof such as dicyanoperylenediimide (PDI-CN₂).

Examples of such preferred organic semiconductor materials are poly-3-hexylthiophene, poly(triarylamine), anthracene, pentacene, perylene, polyparaphenylene, polyparaphenylene vinylene and polyfluorene.

However, the semiconductor material that is very particularly preferred is constituted of silicon nanowires and/or nanotubes and/or carbon nanowires and/or nanotubes and/or nanowires and/or nanotubes of a material based on silicon and germanium such as an alloy of molar composition Si_{0.7}Ge_{0.3}.

As regards the insulating dielectric material, this is an insulating material, advantageously based on silicon, such as for example silicon oxide, based on aluminum, such as for example aluminum oxide, or based on an organic material such as polyhexene diimide.

The receptor molecule A is grafted to the insulating dielectric material of the electrical device.

For this purpose, preferably, the receptor molecule A comprises a group R comprising a function that enables the receptor molecule A to be grafted to the insulating dielectric material.

The function that enables the grafting, which may constitute the group R in its entirety, is adapted to the insulating dielectric material. The group R is generally selected from trihalosilane groups, tri(C₁ to C₄)alkoxysilane groups, and carboxylic and/or sulfonic and/or phosphoric acids.

The grafting of the group R may lead to the formation of a self-assembled monolayer.

Thus, when the insulating dielectric material is based on silicon, and more particularly is silicon oxide (SiO₂), the group R (or more specifically the function of the group R) is a trihalosilane or tri(C₁ to C₄)alkoxysilane group, most preferably a trimethoxysilane group.

When the insulating dielectric material is a material based on aluminum, and more particularly is aluminum oxide (Al₂O₃), the group R comprises or is a trihalosilane or tri(C₁ to C₄)alkoxysilane group, preferably a trimethoxysilane group.

When the insulating dielectric material is an organic insulating dielectric material, and more particularly polyhexene diimide, the group R comprises or is constituted of a trihalosilane or tri(C₁ to C₄)alkoxysilane group, preferably a trimethoxysilane group.

As regards the group capable of reacting with the compounds of interest to be detected and/or quantified, that is to say the group R₁, this group will of course depend on the nature of the compounds of interest.

The grafting groups R and the group capable of reacting with the compound of interest, i.e. the group R₁, may be separated from one another by a spacer part.

This spacer part may be constituted of a linear or branched, C₁ to C₂₀ inclusive hydrocarbon-based chain.

The expression “C₁ to C₂₀ hydrocarbon-based chain” denotes, in the invention, a chain composed of 1 to 20 carbon atoms bonded together by saturated bonds (single bonds) and/or unsaturated bonds (double and/or triple bonds).

It may contain at least one heteroatom and/or an aromatic radical and/or a heteroatomic radical.

The group R₁, when the compounds of interest are organophosphorus molecules, is constituted of a group comprising a primary alcohol group located in spatial proximity to a tertiary amine group.

In this case, and in a first variant, the receptor molecule A is a derivative of Kemp's acid and has the general formula (I) below:

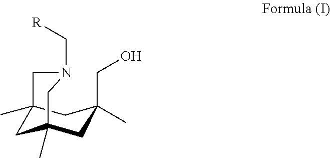

in which R represents the grafting group or group comprising a function for grafting of the receptor molecule, optionally separated from the nitrogen atom by a spacer part.

Still in the case where the compounds of interest to be detected are organophosphorus compounds, the receptor molecule A may also be a molecule of general formulae (II) or (III) below:

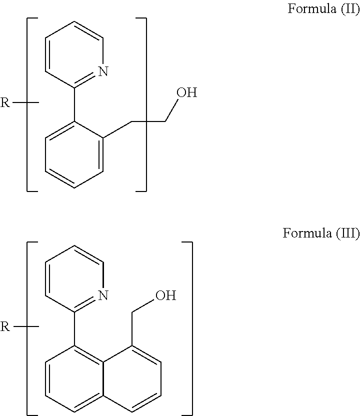

A receptor molecule A of formula (I) that is particularly preferred in the invention is a molecule comprising, as group R₁, a 1,5,7-trimethyl-3-azabicyclo[3.3.1]nonane-7-methanol group, and more particularly in which, at the same time, the grafting group R is a trimethoxysilane group.

With the receptor molecules A of formula (I) or of formula (II) or (III), an unstable phosphate ester intermediate is formed, during the exposure of the receptor molecule A to an organophosphorus compound, by reaction between the primary alcohol and the organophosphorus compound.

This is followed by an intramolecular cyclization via nucleophilic substitution of the phosphate ester intermediate by the tertiary amine and the formation of a quaternary ammonium.

During the cyclization reaction a salt is formed and therefore different electrical charges (cations and anions) are generated.

The generation of a charge via the creation of the ammonium function makes it possible to abruptly modify the electrostatic environment of the molecule and it is this modification which is measured by the detecting and/or measuring device of the detecting and/or quantifying apparatus of the invention, for example by measurement of the variation of the current or of the voltage.

When the compounds of interest are mercuric ions, the receptor molecule A comprises, besides the grafting group on the insulating dielectric material, as defined above, a group R₁ which will enable the mercuric ions to be complexed.

Thus, the receptor molecule A in this case is a molecule derived from a compound that complexes the mercuric ions Hg²⁺.

Such compounds that are preferred in the invention are dithia-dioxa-monoaza crown ether, an N,N′-(hydroxyethyl)amine, an N,N′-(carboxyethyl)amine and mixtures of at least two of these compounds.

One compound that is very particularly preferred in the case of detecting and/or quantifying mercuric ions Hg²⁺ is dithia-dioxa-monoaza crown ether.

Of course, the grafting group of the receptor molecule A in this case may also be bonded to the group R that complexes the mercuric ions Hg²⁺ via a spacer part, which may be the same as that defined previously.

During the complexing of the mercuric ions Hg²⁺, there is a variation of the conduction current between the two electrodes of the electrical device according to the invention and it is this variation of the conduction current between the two electrodes that is detected and/or measured by the device for measuring the variation of the positive charge between the two electrodes according to the invention.

When the compounds of interest are nitrogen-containing compounds, such as nitrogen-containing explosives, for instance TNT, the group R₁ is an electron-rich group such as a polymethoxyarene group, for example a dimethoxybenzene group.

When the compounds of interest are basic molecules such as ammonia, the group R₁ is an acid group, such as a carboxylic, sulfonic or phosphoric acid group, for example a benzoic acid group.

The detecting and/or quantifying apparatus of the invention has a simple structure that enables it to be produced at low cost and on a large scale.

Indeed, the two active parts of this sensor, namely the purely electrical part constituted of the electrodes and of the semiconductor and the layer of receptor molecules A, are both on the same face of the substrate.

It is therefore very easy to manufacture in-line, unlike the case in which the two faces of the substrate comprise active parts.

This also enables the apparatus of the invention to be of very small size, requiring little energy in order to function, promoting its portable nature.

In order to better understand the invention, an exemplary embodiment will now be described by way of a purely illustrative and nonlimiting example.

### EXAMPLE 1

### Manufacture of an Apparatus for Detecting and/or Quantifying an Organophosphorus Compound in Gaseous Form, Diisopropyl Fluorophosphate (DFP)

Electrical devices were manufactured on a silicon substrate covered with a layer of silicon oxide, comprising at its surface, a layer of silicon oxide having a thickness of 100 nm.

Electrodes made of Ti/Au (5/30 nm) were deposited by evaporation on the silicon oxide surface, which constitutes the insulating dielectric material of the electrical device according to the invention.

The surface of the silicon oxide layer is activated by a plasma treatment in order to create surface hydroxyl functions.

The surface is then functionalized by immersion, at room temperature for 24 hours, in a 1 mM solution of 11-azidoundecyltrimethoxysilane in toluene.

The substrate is then rinsed thoroughly with dichloromethane, water and acetone then dried under a stream of argon.

Next, the group that gives rise to the cyclization of the organophosphorus compound was grafted to the azide monolayer in N,N′-dimethylformamide (DMF) at room temperature by submerging the substrate in a 2 mM solution of 1-(4-ethynylbenzyl)-1,5,7-trimethyl-3-azabicyclo[3.3.1]nonane-7-methanol containing 1 mol % of CuSO₄.5H₂O and 5 mol % of Na ascorbate relative to the alkyne compound.

The substrate thus functionalized is then sonicated successively in DMF, water and methanol for 2 minutes then dried under a stream of argon.

Next, the layer of semiconductor material was deposited on the surface of the thus functionalized insulating dielectric material.

This was carried out by spraying a solution of carbon nanotubes.

The electrical device is then dried in a vacuum oven at 100° C., 1 mbar for 12 hours.

This device is brought together with diisopropyl fluorophosphate vapor and the variation of resistance was measured.

A relative variation of the resistance ΔR/R of 42% was measured.

In the aforegoing example 1, the grafting of the receptor molecule A was carried out in two steps: firstly the molecule comprising a spacer part and the trimethoxysilane grafting group was grafted onto the layer of insulating dielectric material then the cyclization group R bound to another part of the spacer part of the receptor molecule A, the 1-(4-ethynylbenzyl) part, was grafted to the free part of the azidoundecyl grafting group.

However, the grafting of the receptor molecule A may be carried out in a single step, without departing from the scope of the invention.

### EXAMPLE 2

### Manufacture of an Apparatus for Detecting and/or Quantifying an Organophosphorus Compound in Gaseous Form, Diisopropyl Fluorophosphate (DFP)

Electrical devices were manufactured on a silicon substrate covered with a layer of silicon oxide, comprising at its surface, a layer of silicon oxide having a thickness of 100 nm.

Electrodes made of Ti/Au (5/30 nm) were deposited by evaporation on the silicon oxide surface, which constitutes the insulating dielectric material of the electrical device according to the invention.

Next, the layer of semiconductor material was deposited on the surface of the dielectric material.

This was carried out by spraying a solution of carbon nanotubes.

The surface that is still accessible since it is not covered by the carbon nanotubes is then functionalized by immersion, at room temperature for 24 hours, in a 1 mM solution of 11-azidoundecyltrimethoxysilane in toluene.

The substrate is then rinsed thoroughly with dichloromethane, water and acetone then dried under a stream of argon.

Next, the group that gives rise to the cyclization of the organophosphorus compound was grafted to the azide monolayer in N,N′-dimethylformamide (DMF) at room temperature by submerging the substrate in a 2 mM solution of 1-(4-ethynylbenzyl)-1,5,7-trimethyl-3-azabicyclo[3.3.1]nonane-7-methanol containing 1 mol % of CuSO₄.5H₂O and 5 mol % of Na ascorbate relative to the alkyne compound.

The substrate thus functionalized is then sonicated successively in DMF, water and methanol for 2 minutes then dried under a stream of argon.

The electrical device is then dried in a vacuum oven at 100° C., 1 mbar for 12 hours.

This device is brought together with diisopropyl fluorophosphate vapor and the variation of resistance was measured.

A relative variation of the resistance ΔR/R of 17% was measured.

In the aforegoing example 1, the grafting of the receptor molecule A was carried out in two steps: firstly the molecule comprising a spacer part and the trimethoxysilane grafting group was grafted onto the layer of insulating dielectric material then the cyclization group R bound to another part of the spacer part of the receptor molecule A, the 1-(4-ethynylbenzyl) part, was grafted to the free part of the azidoundecyl grafting group.

However, the grafting of the receptor molecule A may be carried out in a single step, without departing from the scope of the invention.

### EXAMPLE 3

### Manufacture of an Apparatus for Detecting and/or Quantifying Mercuric Ions

Electrical devices were manufactured on a silicon substrate covered with a layer of silicon oxide, comprising at its surface, a layer of silicon oxide having a thickness of 100 nm.

Electrodes made of Ti/Au (5/30 nm) were deposited by evaporation on the silicon oxide surface, which constitutes the insulating dielectric material of the electrical device according to the invention.

The surface of the silicon oxide layer is activated by a plasma treatment in order to create surface hydroxyl functions.

The surface is then functionalized by immersion, at room temperature for 24 hours, in a 1 mM solution of 11-azidoundecyltrimethoxysilane in toluene.

The substrate is then rinsed thoroughly with dichloromethane, water and acetone then dried under a stream of argon.

The group complexing the Hg²⁺ was grafted to the azide monolayer in N,N′-dimethylformamide (DMF) at room temperature by submerging the substrate in a 2 mM solution of N-(4-ethynylphenyl)-dithia-dioxa-monoaza crown ether containing 1 mol % of CuSO₄.5H₂O and 5 mol % of Na ascorbate relative to the alkyne compound.

The substrate thus functionalized is then sonicated successively in DMF, water and methanol for 2 minutes then dried under a stream of argon.

Next, the layer of semiconductor material was deposited on the surface of the thus functionalized insulating dielectric material.

This was carried out by spraying a solution of carbon nanotubes.

The electrical device is then dried in a vacuum oven at 100° C., 1 mbar for 12 hours.

This device is brought together with a 10 μM solution of mercury(II) perchlorate for 5 minutes and the variation of resistance was measured.

A relative variation of the resistance ΔR/R of 14% was measured.

In the aforegoing example 2, the grafting of the receptor molecule A was carried out in two steps: firstly the molecule comprising a spacer part and the trimethoxysilane grafting group was grafted onto the layer of insulating dielectric material then the cyclization group R bound to another part of the spacer part of the receptor molecule A, the 1-(4-ethynylbenzyl) part, was grafted to the free part of the azidoundecyl grafting group.

However, the grafting of the receptor molecule A may be carried out in a single step, without departing from the scope of the invention.

### EXAMPLE 4

### Manufacture of an Apparatus for Detecting and/or Quantifying Mercuric Ions

Electrical devices were manufactured on a silicon substrate covered with a layer of silicon oxide, comprising at its surface, a layer of silicon oxide having a thickness of 100 nm.

Electrodes made of Ti/Au (5/30 nm) were deposited by evaporation on the silicon oxide surface, which constitutes the insulating dielectric material of the electrical device according to the invention.

The layer of semiconductor material was then deposited on the surface of the thus functionalized insulating dielectric material by spraying a solution of carbon nanotubes.

The surface is then functionalized by immersion, at room temperature for 24 hours, in a 1 mM solution of 11-azidoundecyltrimethoxysilane in toluene.

The substrate is then rinsed thoroughly with dichloromethane, water and acetone then dried under a stream of argon.

The group complexing the Hg²⁺ was grafted to the azide monolayer in N,N′-dimethylformamide (DMF) at room temperature by submerging the substrate in a 2 mM solution of N-(4-ethynylphenyl)-dithia-dioxa-monoaza crown ether containing 1 mol % of CuSO₄.5H₂O and 5 mol % of Na ascorbate relative to the alkyne compound.

The substrate thus functionalized is then sonicated successively in DMF, water and methanol for 2 minutes then dried under a stream of argon.

The electrical device is then dried in a vacuum oven at 100° C., 1 mbar for 12 hours.

This device is brought together with a 1011M solution of mercury(II) perchlorate for 5 minutes and the variation of resistance was measured.

A relative variation of the resistance ΔR/R of 7% was measured.

In the aforegoing example 2, the grafting of the receptor molecule A was carried out in two steps: firstly the molecule comprising a spacer part and the trimethoxysilane grafting group was grafted onto the layer of insulating dielectric material then the cyclization group R bound to another part of the spacer part of the receptor molecule A, the 1-(4-ethynylbenzyl) part, was grafted to the free part of the azidoundecyl grafting group.

However, the grafting of the receptor molecule A may be carried out in a single step, without departing from the scope of the invention.

The layers formed from the receptor molecules generally and preferably have a thickness of less than 3 nm, which is compatible with a miniaturization of the apparatus of the invention.

These layers are coated with the layer of semiconductor material and do not cover it.

1. An apparatus for selectively detecting and/or quantifying compounds of interest present in gaseous form or in solution in a solvent comprising:
an electrical device comprising:
two electrodes,
a layer of insulating dielectric material,
a layer comprising a layer of receptor molecule comprising at least one receptor molecule A, said receptor molecule A comprising a group R₁ capable of reacting with the compounds of interest,
a layer of semiconductor material, and
a device for detecting and/or measuring the variation of positive charges between the two electrodes,
characterized in that the layer of receptor molecule A is grafted to the layer of insulating dielectric material and coated with the layer of semiconductor material.

2. The apparatus as claimed in claim 1, characterized in that the at least one receptor molecule A furthermore comprises a group R enabling the grafting of the receptor molecule A to the insulating dielectric material.

3. The apparatus as claimed in claim 1, characterized in that the insulating dielectric material is chosen from insulating dielectric materials based on silicon, insulating dielectric materials based on aluminum or on hafnium and organic insulating dielectric materials.

4. The apparatus as claimed in claim 1, characterized in that the insulating dielectric material is chosen from silicon oxide, aluminum oxide and polyhexene diimide.

5. The apparatus as claimed in claim 2, characterized in that the insulating dielectric material is based on silicon, preferably is silicon oxide SiO₂, and in that the group R of the receptor molecule A is a trihalosilane or tri(C₁ to C₄)alkoxysilane group, preferably a trimethoxysilane group.

6. The apparatus as claimed in claim 2, characterized in that the insulating dielectric material is based on aluminum, preferably is aluminum oxide Al₂O₃, and in that the group R of the receptor molecule A is a trihalosilane or tri(C₁ to C₄)alkoxysilane group, preferably a trimethoxysilane group.

7. The apparatus as claimed in claim 2, characterized in that the insulating dielectric material is an organic dielectric insulating material, preferably is polyhexene diimide, and in that the group R of the receptor molecule A is a trihalosilane or tri(C₁ to C₄)alkoxysilane group, preferably a trimethoxysilane group.

8. The apparatus as claimed in claim 2, characterized in that the receptor molecule A furthermore comprises a spacer part connecting the group R to the group R₁, this spacer part being constituted of a linear or branched C₁ to C₂₀ inclusive hydrocarbon-based chain, and possibly containing at least one heteroatom and/or aromatic radical and/or heteroaromatic radical.

9. The apparatus as claimed claim 1, characterized in that the compounds of interest are organophosphorus compounds and in that the group R₁ of the receptor molecule A is a group constituted of a primary alcohol group located in spatial proximity to a tertiary amine group.

10. The apparatus as claimed in claim 9, characterized in that said receptor molecule A is obtained from Kemp's acid and has the general formula (I) below: 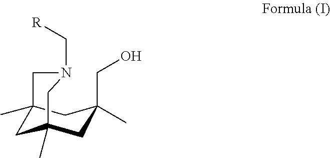
in which R represents the grafting group, optionally provided with the spacer part.

11. The apparatus as claimed in claim 9, characterized in that said receptor molecule A is a molecule of general formula (II) below: 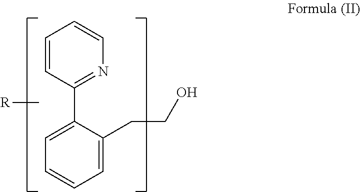
in which R represents the grafting group, optionally provided with the spacer part.

12. The apparatus as claimed in claim 9, characterized in that said receptor molecule A is a molecule of general formula (III) below: 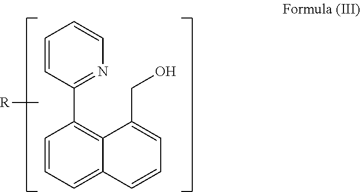
in which R represents the grafting group, optionally provided with the spacer part.

13. The apparatus as claimed in claim 9, characterized in that the group R is a trimethoxysilane group.

14. The apparatus as claimed claim 1, characterized in that the compounds of interest are mercuric ions Hg²⁺, and in that the group R₁ of the receptor molecule A is chosen from a dithia-dioxa-monoaza crown ether compound, an N,N′-(hydroxyethyl)amine, an N,N′-(carboxyethyl)amine and mixtures of at least two of these compounds.

15. The apparatus as claimed in claim 14, characterized in that the group R₁ of the receptor molecule A is a dithia-dioxa-monoaza crown ether group.

16. The apparatus as claimed in claim 1, characterized in that the compounds of interest are nitrogen-containing compounds and in that the group R₁ of the receptor molecule A is a polymethoxyarene group, preferably dimethoxybenzene.

17. The apparatus as claimed in claim 1, characterized in that the compounds of interest are basic compounds and in that the group R₁ of the receptor molecule A is an acid group.

18. The apparatus as claimed in claim 1, characterized in that the electrical device is of resistive type.

19. The apparatus as claimed in claim 1, characterized in that the electrical device is a field-effect transistor.

20. The apparatus as claimed in claim 1, characterized in that the layer of semiconductor material is a layer of carbon nanotubes and/or of nanowires based on Si and/or of graphene sheets.

21. A method for detecting and/or quantifying compounds of interest, characterized in that it comprises the following steps:
a) contacting of the sample liable to contain the compounds of interest with the at least one receptor molecule A of the detecting and/or quantifying apparatus as claimed in claim 1, and
b) reading the charge variation induced by the reaction of the receptor molecule A with the compound of interest by measuring the difference in current or voltage between the two electrodes of the electrical device.
